(19) United States
(12) Patent Application Publication
(10) Pub. No.: US 2016/0093922 A1
(43) Pub. Date: Mar. 31, 2016

(54) POSITIVE ELECTRODE FOR NONAQUEOUS ELECTROLYTE SECONDARY BATTERY AND NONAQUEOUS ELECTROLYTE SECONDARY BATTERY

(71) Applicant: Panasonic Corporation, Osaka (JP)

(72) Inventors: KAZUKI ENDO, Osaka (JP); YASUNARI SUGITA, Osaka (JP); TOMOKI SHIOZAKI, Osaka (JP)

(21) Appl. No.: 14/814,485

(22) Filed: Jul. 30, 2015

(30) Foreign Application Priority Data
Sep. 29, 2014 (JP) 2014-198467

(51) Int. Cl. H01M 10/42; H01M 10/0525; H01M 4/525; H01M 4/131; H01M 4/505; H01M 4/64; H01M 4/62

(52) U.S. Cl. CPC H01M 10/4235; H01M 4/64; H01M 10/0525; H01M 4/623; H01M 4/625; H01M 4/131; H01M 4/505; H01M 4/525; H01M 2004/028

(57) ABSTRACT

A positive electrode according to an embodiment includes a positive electrode current collector, a positive electrode mixture layer disposed on the current collector, and an intermediate layer disposed between the positive electrode current collector and the positive electrode mixture layer. The intermediate layer includes particles, the particles are mainly composed of a material having a thermal conductivity of 100 W/m·K or more and a specific resistance of 10³ Ω·m or more, and the particles have a Vickers hardness of 5 GPa or more.

### BACKGROUND

1. Technical Field

The present disclosure relates to a positive electrode for a nonaqueous electrolyte secondary battery and a nonaqueous electrolyte secondary battery.

2. Description of the Related Art

Japanese Unexamined Patent Application Publication No. 2000-149924 (Patent Literature 1) discloses a nonaqueous electrolyte secondary battery including an intermediate layer mainly composed of graphite and disposed between a positive electrode mixture layer and a positive electrode current collector, in order to improve the safety during overcharge. Patent Literature 1 describes that such a structure can moderate the exothermic reaction of the positive electrode active material and allows the shut-down function of, for example, a separator to be surely expressed, even in overcharge.

The battery according to Patent Literature 1 has a possibility of improving the safety during overcharge, but still has room for improvement in view of occurrence of an internal short circuit by, for example, nail sticking. In particular, a battery having a high energy density generates a large amount of heat in occurrence of an internal short circuit. It is therefore an important object to enhance safety by prevent such heat generation.

### SUMMARY

In one general aspect, the techniques disclosed here feature a positive electrode for a nonaqueous electrolyte secondary battery including a positive electrode current collector, a positive electrode mixture layer disposed on the current collector, and an intermediate layer disposed between the positive electrode current collector and the positive electrode mixture layer. The intermediate layer includes particles, the particles are mainly composed of a material having a thermal conductivity of 100 W/m·K or more and a specific resistance of 10³ Ω·m or more, and the particles have a Vickers hardness of 5 GPa or more.

The positive electrode for a nonaqueous electrolyte secondary battery according to a general aspect of the present disclosure can inhibit heat generation in occurrence of an internal short circuit by, for example, nail sticking and can further improve the safety in occurrence of an abnormal situation, such as nail sticking.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view schematically illustrating a positive electrode for a nonaqueous electrolyte secondary battery as an embodiment;

FIG. 2A is a diagram for explaining the advantageous functional effects of a positive electrode for a nonaqueous electrolyte secondary battery as an embodiment; and

FIG. 2B is a diagram for explaining the advantageous functional effects of the positive electrode for a nonaqueous electrolyte secondary battery as an embodiment.

### DETAILED DESCRIPTION

The positive electrode for a nonaqueous electrolyte secondary battery as an embodiment of the present disclosure includes an intermediate layer between a positive electrode current collector and a positive electrode mixture layer, as described above. The intermediate layer includes particles, the particles are mainly composed of a material having a thermal conductivity of 100 W/m·K or more and a specific resistance of 10³ Ω·m or more, and the particles have a Vickers hardness of 5 GPa or more.

If an internal short circuit occurs in a nonaqueous electrolyte secondary battery by, for example, nail sticking, the battery temperature is increased by the Joule heat generated at the short-circuited position. In the battery including the positive electrode described above, the intermediate layer having a high thermal conductivity effectively releases the heat generated at the positive electrode to prevent the battery temperature from increasing. In addition, since the intermediate layer is mainly composed of hard particles having a Vickers hardness of 5 GPa or more, the particles sink into the positive electrode current collector to exhibit a strong anchor effect between the intermediate layer and the positive electrode current collector. Accordingly, even in an internal short circuit caused by, for example, nail sticking, the intermediate layer protects the positive electrode current collector without peeling off from the current collector. Since the particles constituting the intermediate layer are mainly composed of a material having a specific resistance of 10³ Ω·m or more, for example, even if the positive electrode mixture layer is peeled off, a low-resistance short circuit causing a flow of a large current is prevented from occurring.

The nonaqueous electrolyte secondary battery including the positive electrode in an embodiment of the present disclosure can reduce heat generation due to an internal short circuit caused by, for example, nail sticking and can further enhance the safety in occurrence of an abnormal situation, such as nail sticking.

The particles constituting the intermediate layer desirably have an average particle size of 0.1 to 10 μm and are desirably at least one selected from the group consisting of diamond particles, aluminum nitride particles, and silicon carbide particles. The content of the particles in the intermediate layer is desirably 70% to 95% by weight based on the total weight of the intermediate layer. In such an embodiment, the heat generation due to an internal short circuit can be effectively prevented.

An embodiment of the present disclosure will now be described in detail.

The drawings referred to in explanation of the embodiment are schematic, and the dimension ratios of components and other factors shown in the drawings may be different from those of actual one. Specific dimensional ratios and other factors can be judged from the following descriptions.

The nonaqueous electrolyte secondary battery according to an embodiment includes a positive electrode described above, a negative electrode, and a nonaqueous electrolyte containing a nonaqueous solvent. A separator is desirably disposed between the positive electrode and the negative electrode. In an exemplary structure of the nonaqueous electrolyte secondary battery, an electrode assembly produced by winding the positive electrode and the negative electrode with the separator therebetween and a nonaqueous electrolyte are accommodated in an outer package. Alternatively, other electrode assemblies, such as a lamination type electrode assembly composed of a positive electrode and a negative electrode laminated with a separator therebetween, may be employed instead of the wound type electrode assembly. The nonaqueous electrolyte secondary battery may have any shape, such as a cylindrical, rectangular, coin, button, or laminate shape.

### [Positive Electrode]

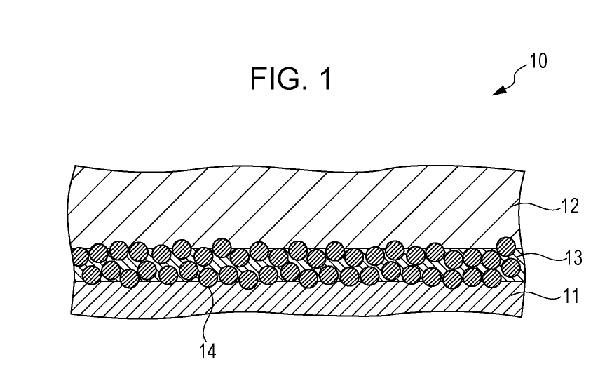

FIG. 1 is a view schematically illustrating a cross-section of the positive electrode 10 as an embodiment.

As shown in FIG. 1, the positive electrode 10 includes a positive electrode current collector 11 of, for example, metal foil, a positive electrode mixture layer 12 disposed on the current collector 11, and an intermediate layer 13 disposed between the positive electrode current collector 11 and the positive electrode mixture layer 12. The positive electrode current collector 11 is, for example, foil of a metal, such as aluminum, that is stable in the potential range of the positive electrode or a film having a surface layer of such a metal. The positive electrode mixture layer 12 and the intermediate layer 13 are, for example, disposed on each surface of the positive electrode current collector 11.

The positive electrode mixture layer 12 desirably includes a conductive material and a binding material, in addition to a positive electrode active material. The positive electrode mixture layer 12 is formed by, for example, applying a mixture slurry containing a positive electrode active material, a conductive material, a binding material, and other materials onto a positive electrode current collector 11 having an intermediate layer 13 formed thereon; and drying and then pressing the coating film. The rolling of the positive electrode mixture layer 12 also presses the intermediate layer 13 to improve the adhesion between the intermediate layer 13 and the positive electrode current collector 11 and also between the intermediate layer 13 and the positive electrode mixture layer 12.

The positive electrode active material is, for example, a lithium-transition metal oxide containing a transition metal element such as Co, Mn, or Ni. Examples of the lithium-transition metal oxide include LiₓCoO₂, LiₓNiO₂, LiₓMnO₂, LixCo_{y}Ni_{1-y}O₂, LiₓCo_{y}M_{1-y}O_{z}, LiₓNi_{1-y}M_{y}O_{z}, LiₓMn₂O₄, LiₓMn_{2-y}M_{y}O₄, LiMPO₄, Li₂MPO₄F (M: at least one of Na, Mg, Sc, Y, Mn, Fe, Co, Ni, Cu, Zn, Al, Cr, Pb, Sb, and B, 0<x≦1.2, 0<y≦0.9, and 2.0≦z≦2.3). These lithium-transition metal oxides may be used alone or as a mixture of two or more thereof.

The conductive material is used for enhancing the electrical conductivity of the positive electrode mixture layer. Examples of the conductive material include carbon materials such as carbon black, acetylene black, Ketjen black, and graphite. These conductive materials may be used alone or in combination of two or more thereof.

The binding material is used for maintaining the good contact between the positive electrode active material and the conductive material and for enhancing the binding property of, for example, the positive electrode active material to the surface of the positive electrode current collector. Examples of the binding material include fluorine resins, such as polytetrafluoroethylene (PTFE) and polyvinylidene fluoride (PVdF), polyacrylonitrile (PAN), polyimide resins, acrylic resins, and polyolefin resins. These resins may be used in combination with, for example, carboxymethyl cellulose (CMC) or its salt (which is, for example, CMC-Na, CMC-K, or CMC-NH₄ or may be a partially neutralized salt) or polyethylene oxide (PEO). These binding materials may be used alone or in combination of two or more thereof.

The content (weight per unit volume) of the positive electrode active material in the positive electrode mixture layer 12 is not particularly limited and is desirably 2.7 g/cm³ or more and more desirably 2.9 g/cm³ or more. The upper limit of the content of the positive electrode active material is, for example, 3.8 g/cm³. If the content of the positive electrode active material is at least 2.7 g/cm³, for example, the particles 14 of the intermediate layer 13 are brought into contact with the positive electrode active material and are readily strongly pressed to the positive electrode current collector 11 during rolling of the positive electrode mixture layer 12, which improves the adhesion between the intermediate layer 13 and the positive electrode current collector 11.

The intermediate layer 13 contains particles 14 that are mainly composed of a material having a thermal conductivity of 100 W/m·K or more and a specific resistance of 10³ Ω·m or more and have a Vickers hardness of 5 GPa or more. The intermediate layer 13 acts so as to prevent the heat generation due to an internal short circuit. Here, the term “being mainly composed” refers to that the weight proportion of the material is the highest among the materials constituting the particles 14. Although the particles 14 may contain, for example, a material having a thermal conductivity of less than 100 W/m·K or a specific resistance of less than 10³ Ω·m, the particles 14 are mainly composed of a material having a thermal conductivity of 100 W/m·K or more and a specific resistance of 10³ Ω·m or more. The amount of the material having a thermal conductivity of 100 W/m·K or more and a specific resistance of 10³ Ω·m or more is desirably at least 50%, more desirably 60% or more, and most desirably 70% or more based on the total weight of the particles 14.

The intermediate layer 13 is desirably mainly composed of the particles 14. That is, the weight proportion of the particles 14 in the intermediate layer 13 is the highest among the materials constituting the intermediate layer 13. The content (weight proportion) of the particles 14 is, for example, at least 50% based on the total weight of the intermediate layer 13. The thickness of the intermediate layer 13 is desirably smaller than those of the positive electrode current collector 11 and the positive electrode mixture layer 12 and can be appropriately changed depending on, for example, the particle diameter of the particles 14. The average thickness is desirably 1 to 10 μm and more desirably 2 to 5 μm.

The intermediate layer 13 desirably contains a conductive material and a binding material, in addition to the particles 14. The conductive material can be, for example, a conductive material that is used in the positive electrode mixture layer 12, such as carbon black or acetylene black. The binding material also can be a binding material that is used in the positive electrode mixture layer 12, such as a fluorine resin, e.g., PTFE or PVdF. The intermediate layer 13 is formed by, for example, applying a slurry containing the particles 14, a conductive material, and a binding material onto the positive electrode current collector 11, drying the coating film, and then rolling the film together with the positive electrode mixture layer 12.

The content of the particles 14 in the intermediate layer 13 is desirably 70% to 95% by weight and more desirably 75% to 90% by weight, based on the total weight of the intermediate layer 13. A content of the particles 14 within this range, for example, readily provides satisfactory adhesion between the intermediate layer 13 and the positive electrode current collector 11 and can effectively prevent the heat generation due to an internal short circuit. The content of the conductive material in the intermediate layer 13 is desirably 5% to 20% by weight based on the total weight of the intermediate layer 13, although it slightly varies depending on, for example, the specific resistance and the type of the conductive material of the particles 14. The content of the binding material in the intermediate layer 13 is desirably 1% to 10% by weight based on the total weight of the intermediate layer 13, although it slightly varies depending on, for example, the diameter and circularity of the particles 14 and the type of the binding material.

The particles 14 as the main component of the intermediate layer 13 desirably have an average particle diameter of 0.1 to 10 μm and are desirably particles approximate to spheres having an average circularity of 0.6 or more, not particles having a high aspect ratio, such as squamous or fiber shapes. The particles 14 more desirably have an average particle diameter of 0.5 to 5 μm and most desirably 0.7 to 2 μm. The average particle diameter of the particles 14 refers to the particle diameter (volume-average particle diameter) at which the volumetric integrated value is 50% in a particle size distribution measured by a laser diffraction/scattering method (using, e.g., “LA-750”, manufactured by HORIBA, Ltd.). The average circularity of the particles 14 is more desirably 0.7 or more and most desirably 0.8 or more. The average circularity of the particles 14 can be measured by particle image analysis (using, e.g., “FPIA-3000”, manufactured by Sysmex Corporation).

The material as the main component of the particles 14 desirably has a thermal conductivity of at least 100 W/m·K, desirably 150 W/m·K or more, and more desirably 200 W/m·K or more. The particles 14 having a higher thermal conductivity can, for example, efficiently release heat from a short-circuited position and readily prevent an increase in the battery temperature at the time of occurrence of abnormality.

The particles 14 have a Vickers hardness of at least 5 GPa, desirably 7 GPa or more, and more desirably 9 GPa or more. A higher Vickers hardness of the particles 14 allows the particles 14, for example, to readily sink into the positive electrode current collector 11 and thereby prevents the intermediate layer 13 from peeling off from the positive electrode current collector 11.

The material as the main component of the particles 14 desirably has a specific resistance of at least 10³ Ω·m, desirably 10⁵ Ω·m or more, and more desirably 10⁶ Ω·m or more. A higher specific resistance of the particles 14, for example, can reduce the short circuit current that flows when the intermediate layer 13 comes into contact with the negative electrode to readily prevent an increase in the battery temperature at the time of occurrence of abnormality. Although a higher specific resistance of the particles 14 tends to increase the amount of heat generated in the intermediate layer 13, the intermediate layer 13 has a high thermal conductivity and can therefore rapidly diffuse the heat generated at the short-circuited position.

The particles 14 may be any particles that satisfy the above-described physical properties and are desirably at least one selected from the group consisting of diamond particles, aluminum nitride (AlN) particles, and silicon carbide (SiC) particles. The diamond particles have, for example, a thermal conductivity of 2200 W/m·K, a Vickers hardness of 100 GPa, and a specific resistance of 10¹⁴ Ω·m. The AlN particles have, for example, a thermal conductivity of 230 W/m·K, a Vickers hardness of 10 GPa, and a specific resistance of 10¹⁴ Ω·m. The SiC particles have, for example, a thermal conductivity of 270 W/m·K, a Vickers hardness of 23 GPa, and a specific resistance of 10⁸ Ω·m.

At least a part of the particles 14 desirably sink into the positive electrode current collector 11. The intermediate layer 13 is desirably rolled together with the positive electrode mixture layer 12. The particles 14 are strongly pressed to the positive electrode current collector 11 by the rolling and sink into the positive electrode current collector 11. As a result, a strong anchor effect between the intermediate layer 13 and the positive electrode current collector 11 is obtained.

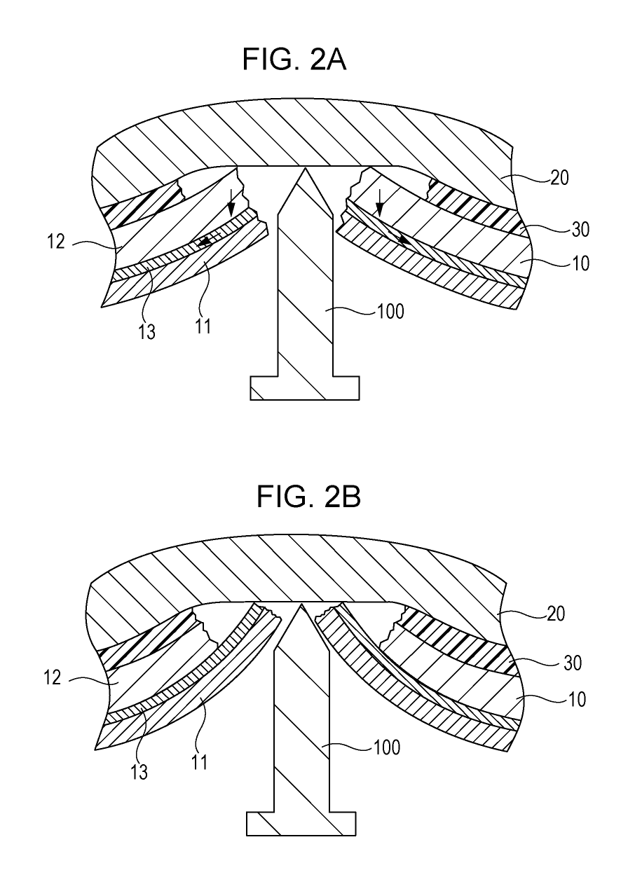

FIGS. 2A and 2B illustrate the appearances of the positive electrodes 10 when an internal short circuit occurred by nail sticking.

FIG. 2A shows a state of an internal short circuit caused by sticking of a nail 100 into a battery to cause breakage of the positive electrode 10 and the separator 30 and cause contact of the positive electrode mixture layer 12 of the positive electrode 10 to the negative electrode 20. In this case, although the heat generation at the short-circuited position (positive electrode mixture layer 12) of the positive electrode 10 is particularly high, the heat can be efficiently released from the short-circuited position in the positive electrode 10 by the intermediate layer 13 having a high thermal conductivity to prevent an increase in the battery temperature.

FIG. 2B shows a state of the intermediate layer 13 being in contact with the negative electrode 20 by peeling off of the positive electrode mixture layer 12 from the positive electrode current collector 11. Although the positive electrode mixture layer 12 is readily peeled off in the periphery of the portion into which a nail 100 stuck, the intermediate layer 13 is hardly peeled off because of its high adhesion to the positive electrode current collector 11 to prevent the direct contact between the positive electrode current collector 11 and the negative electrode 20. As a result, the low-resistance short circuit due to the contact between the positive electrode current collector 11 and the negative electrode 20 is prevented from occurring. The heat generated in the intermediate layer 13 is rapidly diffused from the short-circuited position by the intermediate layer 13 having a high thermal conductivity.

### [Negative Electrode]

The negative electrode is desirably composed of a negative electrode current collector of, for example, metal foil and a negative electrode mixture layer disposed on the current collector. The negative electrode current collector can be, for example, foil of a metal, such as copper, that is stable in the potential range of the negative electrode or a film having a surface layer of such a metal. The negative electrode mixture layer desirably contains a binding material, in addition to a negative electrode active material. Examples of the negative electrode active material include natural graphite, artificial graphite, lithium, silicon, carbon, tin, germanium, aluminum, copper, indium, gallium, lithium alloys, lithium-occluded carbon or silicon compounds, and alloys or mixtures thereof.

Usable examples of the binding material include fluorine resins, PAN, polyimide resins, acrylic resins, and polyolefin resins, as in the positive electrode. When a mixture slurry is prepared using an aqueous solvent, the binding material to be desirably used is CMC or its salt (which is, for example, CMC-Na, CMC-K, or CMC-NH₄ or may be a partially neutralized salt), styrene-butadiene rubber (SBR), polyacrylic acid (PAA) or its salt (which is, for example, PAA-Na or PAA-K or may be a partially neutralized salt), or polyvinyl alcohol (PVA).

### [Nonaqueous Electrolyte]

The nonaqueous electrolyte includes a nonaqueous solvent and an electrolyte salt soluble in the nonaqueous solvent. The nonaqueous electrolyte is not limited to liquid electrolytes (nonaqueous electrolytic solutions) and may be a solid electrolyte, such as gelled polymers. Examples of the nonaqueous solvent include esters, ethers, nitriles such as acetonitrile, amides such as dimethylformamide, and solvent mixtures of two or more thereof. These nonaqueous solvents may contain halogen-substituted derivatives having halogen atoms, such as fluorine atoms, substituted for at least a part of the hydrogen atoms of the solvents.

Examples of the esters include cyclic carbonate esters, such as ethylene carbonate (EC), propylene carbonate (PC), and butylene carbonate; chain carbonate esters such as dimethyl carbonate (DMC), ethyl methyl carbonate (EMC), diethyl carbonate (DEC), methyl propyl carbonate, ethyl propyl carbonate, and methyl isopropyl carbonate; cyclic carboxylate esters, such as γ-butyrolactone (GBL) and γ-valerolactone (GVL); and chain carboxylate esters, such as methyl acetate, ethyl acetate, propyl acetate, methyl propionate (MP), and ethyl propionate.

Examples of the ethers include cyclic ethers, such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and crown ether; and chain ethers, such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

Desired examples of the halogen-substituted derivatives include fluorinated cyclic carbonate esters, such as fluoroethylene carbonate (FEC); fluorinated chain carbonate esters; and fluorinated chain carboxylate esters, such as methyl fluoropropionate (FMP).

The electrolyte salt is desirably a lithium salt. Examples of the lithium salt include LiBF₄, LiClO₄, LiPF₆, LiAsF₆, LiSbF₆, LiAlCl₄, LiSCN, LiCF₃SO₃, LiCF₃CO₂, Li(P(C₂O₄)F₄), LiPF₆₋ₓ(CₙF₂ₙ₊₁)ₓ (1<x<6, n=1 or 2), LiB₁₀Cl₁₀, LiCl, LiBr, LiI, chloroborane lithium, lower aliphatic lithium carboxylate, borates such as Li₂B₄O₇ and Li(B(C₂O₄)F₂), and imides such as LiN(SO₂CF₃)₂ and LiN(C₁F₂ₗ₊₁SO₂)(CₘF₂ₘ₊₁SO₂) (l and m each represent an integer of 1 or more). Lithium salts may be used alone or as a mixture of two or more thereof. Among these lithium salts, from the viewpoint of ionic conductivity, electrochemical stability, and other factors, LiPF₆ is desirably used. The concentration of the lithium salt is desirably 0.8 to 1.8 mol per 1 L of nonaqueous solvent.

### [Separator]

The separator used is a porous sheet having ionic permeability and insulation properties. Examples of the porous sheet include micro-porous thin films, woven fabric, and non-woven fabric. Desired materials of the separator are olefin resins, such as polyethylene and polypropylene, and cellulose. The separator may be a laminate including a cellulose fiber layer and a thermoplastic resin fiber layer, such as a olefin resin.

### EXAMPLES

The present disclosure will now be further described by examples, but is not limited to these examples.

### Example 1

### Production of Positive Electrode

Diamond particles (average particle diameter: 1.0 μm, synthetic single crystal diamond powder SYM 0-2, manufactured by Van Moppes Ltd.), acetylene black (HS100, manufactured by Denki Kagaku Kogyo Kabushiki Kaisha), and polyvinylidene fluoride (PVdF) were mixed at a weight ratio of 80:15:5. A dispersion medium, N-methyl-2-pyrrolidone (NMP), was added to the mixture, followed by stirring with a mixer (T. K. HIVIS MIX, manufactured by PRIMIX Corporation) to prepare a slurry for an intermediate layer. Subsequently, the slurry for an intermediate layer was applied onto aluminum foil serving as a positive electrode current collector, and the coating films on both surfaces were dried to form intermediate layers having a thickness of 3 μm on both surfaces of the aluminum foil.

LiCo_{1/3}Ni_{1/3}Mn_{1/3}O₂, acetylene black (HS100, manufactured by Denki Kagaku Kogyo Kabushiki Kaisha), and polyvinylidene fluoride (PVdF) were mixed at a weight ratio of 95:2.5:2.5. A dispersion medium, N-methyl-2-pyrrolidone (NMP), was added to the mixture, followed by stirring with a mixer (T. K. HIVIS MIX, manufactured by PRIMIX Corporation) to prepare a positive electrode mixture slurry. Subsequently, the positive electrode mixture slurry was applied onto the aluminum foil provided with the intermediate layers, and the coating films were dried and were then rolled with rollers. Thus, positive electrode mixture layers each having a thickness of 60 μm and a mixture density of 3.2 g/cm³ (positive electrode active material density: 3.0 g/cm³) were formed on both surfaces of the aluminum foil to provide a positive electrode composed of the aluminum foil and the intermediate layers and the positive electrode mixture layers formed on both surfaces of the aluminum foil.

### [Production of Negative Electrode]

Artificial graphite (average particle diameter: 10 μm, BET specific surface area: 3 m²/g), carboxymethyl cellulose sodium (CMC-Na), and styrene-butadiene rubber (SBR) were mixed at a weight ratio of 97.5:1.0:1.5, and water was added to the mixture, followed by stirring with a mixer (T. K. HIVIS MIX, manufactured by PRIMIX Corporation) to prepare a negative electrode mixture slurry. Subsequently, the negative electrode mixture slurry was applied onto aluminum foil serving as a negative electrode current collector, and the coating films were dried and were then rolled with rollers. Thus, negative electrode mixture layers each having a thickness of 75 μm and a mixture density of 1.7 g/cm³ were formed on both surfaces of the aluminum foil to provide a negative electrode composed of the aluminum foil and the negative electrode mixture layers formed on both surfaces of the aluminum foil.

### [Preparation of Nonaqueous Electrolytic Solution]

LiPF₆ was added to a solvent mixture of ethylene carbonate (EC) and diethyl carbonate (DEC) mixed at a volume ratio of 3:7 to give a concentration of 1.0 mol/L to prepare a nonaqueous electrolytic solution.

### [Production of Nonaqueous Electrolyte Secondary Battery]

An aluminum tab and a nickel tab were attached to the electrodes, and the positive electrode and the negative electrode were spirally wound with a separator therebetween to produce a wound electrode assembly. The electrode assembly was inserted into an outer package made of an aluminum laminated sheet and was vacuum-dried at 85° C. for 2 hr. Subsequently, the nonaqueous electrolytic solution was injected into the outer package, and the opening of the outer package was sealed to produce a battery having a designed capacity of 800 mAh.

### Example 2

A positive electrode and a battery were produced as in Example 1 except that the thickness of the intermediate layer was 2 μm.

### Example 3

A positive electrode and a battery were produced as in Example 1 except that the thickness of the intermediate layer was 1 μm.

### Example 4

A positive electrode and a battery were produced as in Example 1 except that the thickness of the intermediate layer was 5 μm.

### Example 5

A positive electrode and a battery were produced as in Example 1 except that diamond particles having an average particle diameter of 0.5 μm were used.

### Example 6

A positive electrode and a battery were produced as in Example 1 except that diamond particles having an average particle diameter of 2.0 μm were used.

### Example 7

A positive electrode and a battery were produced as in Example 1 except that AlN particles (average particle diameter: 1.1 μm, high-purity AlN particles, H grade, manufactured by Tokuyama Corporation) were used instead of diamond particles.

### Example 8

A positive electrode and a battery were produced as in Example 7 except that the thickness of the intermediate layer was 2 μm.

### Example 9

A positive electrode and a battery were produced as in Example 7 except that the thickness of the intermediate layer was 1 μm.

### Example 10

A positive electrode and a battery were produced as in Example 7 except that the thickness of the intermediate layer was 5 μm.

### Example 11

A positive electrode and a battery were produced as in Example 1 except that SiC particles (average particle diameter: 0.7 μm, HSC490N, manufactured by Superior Graphite Co.) were used instead of diamond particles.

### Example 12

A positive electrode and a battery were produced as in Example 11 except that the thickness of the intermediate layer was 2 μm.

### Example 13

A positive electrode and a battery were produced as in Example 11 except that the thickness of the intermediate layer was 1 μm.

### Example 14

A positive electrode and a battery were produced as in Example 11 except that the thickness of the intermediate layer was 5 μm.

### Comparative Example 1

A positive electrode and a battery were produced as in Example 1 except that graphite particles (average particle diameter: 4 μm, flake) were used instead of diamond particles.

### Comparative Example 2

A positive electrode and a battery were produced as in Example 1 except that alumina (Al₂O₃) particles (average particle diameter: 0.7 μm, AKP3000, manufactured by Sumitomo Chemical Co., Ltd.) were used instead of diamond particles.

The batteries of Examples 1 to 3 and Comparative Examples 1 and 2 were evaluated for the battery temperatures after nail sticking by the following method. The results of the evaluation are shown in Table 1.

[Evaluation (Nail Sticking Test) of Battery Temperature after Nail Sticking]

Each battery in a full-charge condition was subjected to a nail sticking test by the following procedure:

(1) Each battery was charged with a constant current of 1.0 C (800 mA) to a battery voltage of 4.2 V at an environmental temperature of 25° C. and was then continuously charged at a constant voltage to a current value of 0.05 C (40 mA).

(2) The tip of a wire nail having a diameter of 3 mm was brought into contact with the central portion of the side face of the battery under an environment of a battery temperature of 65° C., and the wire nail was stuck into the battery at a rate of 80 mm/sec along the diameter direction until the wire nail completely pierced the battery.

(3) The battery temperature at the time 30 sec after the sticking of the wire nail was measured by bringing a thermocouple into contact with the surface of the battery.

TABLE

| | | Average | | | | Intermediate | |
|---|---|---|---|---|---|---|---|
| | Intermediate | particle | Thermal | Vickers | Specific | layer | Battery |
| | layer | diameter | conductivity | hardness | resistance | thickness | temperature |
| | particles | (μm) | (W/m · K) | (GPa) | (Ω · m) | (μm) | (° C.) |
| Example 1 | Diamond | 1.0 | 2200 | 100 | 10¹⁴ | 3 | 75 |
| Example 2 | Diamond | 1.0 | 2200 | 100 | 10¹⁴ | 2 | 79 |
| Example 3 | Diamond | 1.0 | 2200 | 100 | 10¹⁴ | 1 | 84 |
| Example 4 | Diamond | 1.0 | 2200 | 100 | 10¹⁴ | 5 | 70 |
| Example 5 | Diamond | 0.5 | 2200 | 100 | 10¹⁴ | 3 | 74 |
| Example 6 | Diamond | 2.0 | 2200 | 100 | 10¹⁴ | 3 | 80 |
| Example 7 | AIN | 1.1 | 230 | 10 | 10¹⁴ | 3 | 87 |
| Example 8 | AIN | 1.1 | 230 | 10 | 10¹⁴ | 2 | 90 |
| Example 9 | AIN | 1.1 | 230 | 10 | 10¹⁴ | 1 | 93 |
| Example 10 | AIN | 1.1 | 230 | 10 | 10¹⁴ | 5 | 81 |
| Example 11 | SiC | 0.7 | 270 | 23 | 10⁸ | 3 | 85 |
| Example 12 | SiC | 0.7 | 270 | 23 | 10⁸ | 2 | 88 |
| Example 13 | SiC | 0.7 | 270 | 23 | 10⁸ | 1 | 91 |
| Example 14 | SiC | 0.7 | 270 | 23 | 10⁸ | 5 | 78 |
| Comparative | Graphite | 4.0 | 150 | <1 | 10⁻⁵ | 3 | 110 |
| Example 1 | | | | | | | |
| Comparative | Al₂O₃ | 0.7 | 20 | 15 | 10¹⁴ | 3 | 100 |
| Example 2 | | | | | | | |

Table demonstrates that the battery temperature of the battery after nail sticking in each Example was significantly lower than that of the battery in each Comparative Example. This result is probably caused by that the intermediate layer of each battery of Examples efficiently diffuses, for example, the heat from the short-circuited position and also prevents the low-resistance short circuit due to the contact between the positive electrode current collector and the negative electrode. In addition, in the batteries of Examples, the electrolytic solution is prevented from, for example, decomposition reaction to prevent the battery temperature from increasing.

The battery temperature of the battery after nail sticking in Comparative Example 1, the battery including an intermediate layer mainly composed of graphite particles having a thermal conductivity of 150 W/m·K, was higher than that of the battery in Comparative Example 2, the battery including an intermediate layer mainly composed of Al₂O₃ particles having a thermal conductivity of 20 W/m·K. This result is probably caused by that in the battery of Comparative Example 1, the intermediate layer is peeled off from the positive electrode current collector by nail sticking to cause a low-resistance short circuit due to the contact between the positive electrode current collector and the negative electrode. It is believed that in the batteries of Examples, since the adhesion between the intermediate layer and the positive electrode current collector is strong, the intermediate layer is hardly peeled off to prevent such a low-resistance short circuit.

What is claimed is:

1. A positive electrode for a nonaqueous electrolyte secondary battery, comprising:
a positive electrode current collector;
a positive electrode mixture layer disposed on the current collector; and
an intermediate layer disposed between the positive electrode current collector and the positive electrode mixture layer, wherein
the intermediate layer includes particles, the particles are mainly composed of a material having a thermal conductivity of 100 W/m·K or more and a specific resistance of 10³ Ω·m or more, and the particles have a Vickers hardness of 5 GPa or more.

2. The positive electrode for a nonaqueous electrolyte secondary battery according to claim 1, wherein the particles have an average particle diameter of 0.1 to 10 μm.

3. The positive electrode for a nonaqueous electrolyte secondary battery according to claim 1, wherein the particles are at least one selected from the group consisting of diamond particles, aluminum nitride particles, and silicon carbide particles.

4. The positive electrode for a nonaqueous electrolyte secondary battery according to claim 1, wherein the intermediate layer contains the particles in an amount of 70% to 95% by weight based on the total weight of the intermediate layer.

5. The positive electrode for a nonaqueous electrolyte secondary battery according to claim 1, wherein the positive electrode mixture layer includes a positive electrode active material in an amount of 2.7 g/cm³ or more.

6. A nonaqueous electrolyte secondary battery comprising:
a positive electrode;
a negative electrode; and
a nonaqueous electrolyte, wherein
the positive electrode includes:
a positive electrode current collector;
a positive electrode mixture layer disposed on the current collector; and
an intermediate layer disposed between the positive electrode current collector and the positive electrode mixture layer, the intermediate layer includes particles, the particles are mainly composed of a material having a thermal conductivity of 100 W/m·K or more and a specific resistance of 10³ Ω·m or more, and the particles have a Vickers hardness of 5 GPa or more.
